(19) United States
(12) Patent Application Publication
(10) Pub. No.: US 2025/0266895 A1
(43) Pub. Date: Aug. 21, 2025

(54) SIDELINK BEAM FAILURE RECOVERY RESPONSE

(71) Applicant: Apple Inc., Cupertino, CA (US)

(72) Inventors: Chunxuan Ye, San Diego, CA (US); Chunhai Yao, Beijing (CN); Dawei Zhang, Saratoga, CA (US); Haitong Sun, Cupertino, CA (US); Hong He, San Jose, CA (US); Huaning Niu, San Jose, CA (US); Sigen Ye, Whitehouse Station, NJ (US); Wei Zeng, Saratoga, CA (US); Weidong Yang, San Diego, CA (US); Yushu Zhang, Beijing (CN)

(21) Appl. No.: 18/857,339

(22) PCT Filed: Apr. 19, 2023
(86) PCT No.: PCT/US2023/019095

§ 371 Date: Oct. 16, 2024

Related U.S. Application Data
(60) Provisional application No. 63/333,083, filed on Apr. 20, 2022.

(51) Int. Cl. H04B 7/06; H04B 17/318; H04W 72/25

(52) U.S. Cl. CPC H04B 7/06964; H04B 17/328; H04W 72/25

(57) ABSTRACT

Disclosed are methods, systems, and computer-readable medium to perform operations including: receiving a beam failure recovery request (BFRQ) from a second UE, the BFRQ including an indication of at least one candidate beam pair for a sidelink interface between the first UE and the second UE, selecting a beam pair from the at least one candidate beam pair, and transmitting a beam failure recovery response (BFRR) to the second UE, the BFRR including an indication of the selected beam pair.

### CROSS-REFERENCE TO RELATED APPLICATIONS

The present application claims priority to U.S. Prov. App. No. 63/333,083, filed on Apr. 20, 2022, entitled “SIDELINK BEAM FAILURE RECOVERY RESPONSE,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded network coverage by using user equipment (UEs) as relays. In particular, the relay UEs establish direct connections with other UEs in order to extend the network coverage to those UEs. The connection that a relay UE establishes with other UEs is referred to as a sidelink communication. Among other examples, the sidelink connection can be either a UE-to-network relay, where the relay UE connects a remote UE to the network, or a UE-to-UE relay, where the relay UE connects a first remote UE to a second remote UE.

### SUMMARY

In accordance with one aspect of the present disclosure, a method to be performed by a first user equipment (UE) involves receiving one or more beam failure recovery requests (BFRQs) from a second UE, where the BFRQ(s) can include an indication of at least one candidate beam or beam pair for a sidelink interface between the first UE and the second UE; selecting a beam pair from the at least one candidate beam pair; and transmitting a beam failure recovery response (BFRR) to the second UE.

Other versions include corresponding systems, apparatus that include one or more processors, and computer programs to perform the actions of methods defined by instructions encoded on computer readable storage devices. These and other versions may optionally include one or more of the following features.

In some implementations, the first UE can measure a received signal power of the BFRQ transmission, and can select the beam pair in response to the received signal power (e.g., RSRP) of the BFRQ transmission satisfying a threshold value.

In some implementations, the first UE may have previously measured and stored received signal power information for the at least one candidate beam pair before receipt of the BFRQ (e.g., during beam maintenance). In this scenario, the second UE can select the new beam or beam pair from the candidate beam pairs based on the stored received signal power information, such as by selecting the beam or beam pair having the greatest stored received signal power among the candidate beam pairs.

In some implementations, the BFRR can include an indication of the selected beam or beam pair, such as a (receiver) beam ID and/or a (transmitter-receiver) beam pair ID.

In some implementations, the selected beam pair is associated with a particular BFRR resource, and the BFRR is transmitted using the particular BFRR resource to implicitly indicate the selected beam pair.

In some implementations, the BFRR is transmitted to the second UE via a PSSCH of the sidelink interface.

In some implementations, the first UE receives an acknowledgement (ACK) of the BFRR from the second UE. In response to the acknowledgement, the first UE (and/or the second UE) implements the selected beam pair as a serving beam pair for the sidelink interface.

In some implementations, the BFRQ is received from the second UE via a PSSCH of the sidelink interface.

In accordance with another aspect of the present disclosure, a method to be performed by a first user equipment (UE) involves detecting a failure of a serving beam pair for a sidelink interface between the first UE and a second UE; transmitting one or more BFRQ(s) to the second UE in response to detecting the failure, where the BFRQ(s) can include an indication of at least one candidate beam or beam pair for the sidelink interface between the first UE and the second UE; and receiving a BFRR from the second UE.

Other versions include corresponding systems, apparatus that include one or more processors, and computer programs to perform the actions of methods defined by instructions encoded on computer readable storage devices. These and other versions may optionally include one or more of the following features.

In some implementations, the BFRR can include an indication of a beam or beam pair (e.g., a beam ID or beam pair ID) selected from the at least one candidate beam or beam pair for the sidelink interface.

In some implementations, the BFRQ is transmitted to the second UE via a PSSCH of the sidelink interface.

In some implementations, the BFRR is received from the second UE on a particular BFRR resource indicative of the selected beam or beam pair.

In some implementations, the beam pair is selected for the sidelink interface based on a received signal power (e.g., RSRP) of the BFRQ transmission.

In some implementations, the beam pair is selected based on received power information for the at least one candidate beam pair recorded before receipt of the BFRQ (e.g., during beam maintenance).

In some implementations, an acknowledgement of the BFRR is transmitted to the second UE. In response to transmitting the acknowledgement, the first UE (and/or the second UE) implements the selected beam pair as a serving beam pair for the sidelink interface.

In accordance with another aspect of the present disclosure, a method to be performed by a base station involves receiving, from a first UE, a BFRQ indicating a failure of a serving beam pair for a sidelink interface between the first UE and a second UE; and transmitting, to the second UE, an indication of the BFRQ.

Other versions include corresponding systems, apparatus that include one or more processors, and computer programs to perform the actions of methods defined by instructions encoded on computer readable storage devices. These and other versions may optionally include one or more of the following features.

In some implementations, the indication can cause the second UE to implement a new beam pair for the sidelink interface between the first UE and the second UE.

In some implementations, the indication of the BFRQ can be transmitted to the second UE via DCI, MAC-CE, or other higher layer signaling.

In some implementations, the BFRQ includes an indication of at least one candidate beam or beam pair for a sidelink interface between the first UE and the second UE. In this scenario, the indication of the BFRQ transmitted to the second UE can include an indication of the at least one candidate beam or beam pair.

In some implementations, the BFRQ does not include an indication of any candidate beams or beam pairs, and the indication of the BFRQ transmitted to the second UE can trigger the second UE to initiate a beam pairing procedure with the first UE.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system, according to some implementations.

FIG. 2A and FIG. 2B illustrate flowcharts of an example sidelink beam failure recovery procedure, according to some implementations.

FIG. 2C illustrates a call flow of the example sidelink beam failure recovery procedure shown in FIG. 2A and FIG. 2B, according to some implementations.

FIG. 3 illustrates a flowchart of another example sidelink beam failure recovery procedure, according to some implementations.

FIG. 4A and FIG. 4B illustrate flowcharts of an example sidelink beam failure recovery procedure, according to some implementations.

FIG. 4C illustrates a call flow of the example sidelink beam failure recovery procedure shown in FIG. 4A and FIG. 4B, according to some implementations.

FIG. 5A, FIG. 5B, and FIG. 5C illustrate flowcharts of an example sidelink beam failure recovery procedure, according to some implementations.

FIG. 6A and FIG. 6B illustrate call flows of the example sidelink beam failure recover procedure shown in FIG. 5A, FIG. 5B, and FIG. 5C, according to some implementations.

FIG. 7A and FIG. 7B illustrate flowcharts of example methods, according to some implementations.

FIG. 8A, FIG. 8B, and FIG. 8C illustrate flowcharts of example methods, according to some implementations.

FIG. 9 illustrates a user equipment (UE), according to some implementations.

FIG. 10 illustrates an access node, according to some implementations.

### DETAILED DESCRIPTION

The Third Generation Partnership Project (3GPP) standards describe a New Radio (NR) vehicle-to-everything (V2X) communication system. One of the features described in the standards is beam failure detection (BFD) on a “Uu” interface between a base station and a user equipment (UE). For a Uu interface, beam failure detection is based on a periodic 1-port Channel State Information Reference Signal (CSI-RS), which is quasi-co-located with a Physical Downlink Control Channel (PDCCH). However, techniques for beam failure detection (and recovery) over a Uu interface cannot directly be applied to a sidelink interface (e.g., between two UEs), as Uu techniques rely on an active communication channel between a UE and a base station. In addition, in Uu, existing random access procedures (e.g., contention-free and contention-based random access procedures) and dedicated access channels (e.g., Physical Random Access Channel (PRACH)) can be leveraged for beam failure detection and recovery. Certain releases of the 3GPP standards do not address beam failure detection on the sidelink interface in which communication with a base station may not be possible or desirable, and in which there are no dedicated random access channels between the UEs to facilitate beam failure detection and recovery. More recently, the work scope of the 3GPP standards includes an enhanced sidelink operation on the FR2 licensed spectrum (e.g., frequency bands between 24.25 Giga Hertz (GHz) to 52.6 GHz). Specifically, one of the areas of study is sidelink beam management, which includes initial beam-pairing, beam maintenance, and beam failure recovery for sidelink operations.

This disclosure describes methods and systems for beam failure recovery for sidelink operations. Among other things, this disclosure describes methods and systems for sidelink beam failure recovery, the triggers of sidelink beam failure recovery, the contents of sidelink beam failure recovery requests and responses, and transmission procedures for sidelink beam failure recovery requests and responses.

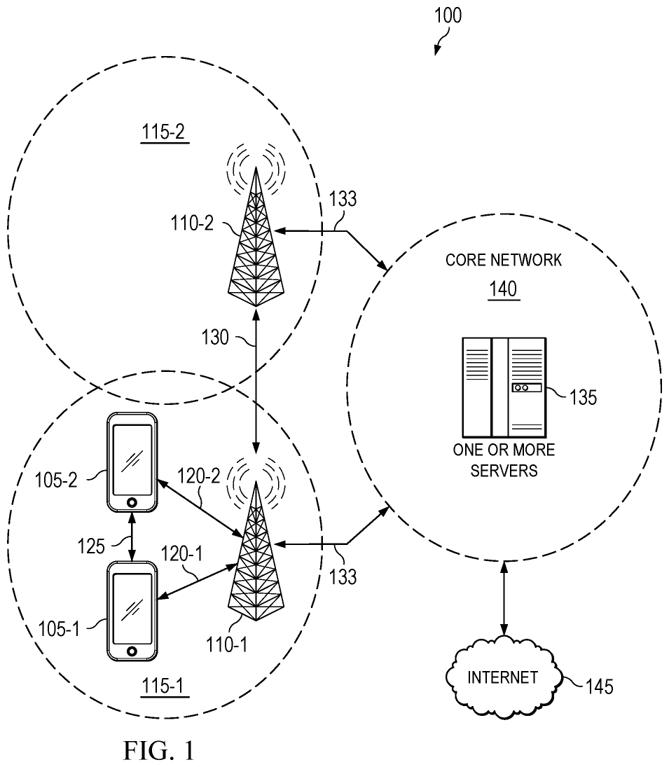

FIG. 1 illustrates an example communication system 100, according to some implementations. It is noted that the system of FIG. 1 is merely one example of a possible system, and that features of this disclosure may be implemented in other wireless communication systems.

The following description is provided for an example communication system 100 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G) systems), IEEE protocols, or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. As used herein, the term “user devices” may refer generally to devices that are associated with mobile actors or traffic participants in the communication system 100, e.g., mobile (able-to-move) communication devices such as vehicles and pedestrian user equipment (PUE) devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a 3GPP LTE protocol, an Advanced long term evolution (LTE-A) protocol, a LTE-based access to unlicensed spectrum (LTE-U), a 5G NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may be “configured” with the parameters from the one or more of the base stations 110. In this disclosure, “(pre)configured” means that “pre-configuration” and “configuration” are both possible.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI can be transmitted in two stages. The 1st-stage SCI is carried on the PSCCH while the 2nd-stage SCI is carried on the corresponding PSSCH. For example, 2-stage SCI can be used by applying the 1st SCI for the purpose of sensing and broadcast communication, and the 2nd SCI carrying the remaining information for data scheduling of unicast/groupcast data transmission. In some examples, the sidelink interface can operate on an unlicensed spectrum (e.g., in the unlicensed 5 Gigahertz (GHz) and 6 GHz bands) or a (licensed) shared spectrum.

In some implementations, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1) and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the sidelink 125 is established through an initial beam pairing procedure. In this procedure, the UEs 105 identify (e.g., using a beam selection procedure) one or more potential beam pairs that could be used for the sidelink 125. A beam pair includes a transmitter beam from a transmitter UE (e.g., UE 105-1) to a receiver UE (e.g., UE 105-2) and a receiver beam from the receiver UE to the transmitter UE. In some examples, the UEs 105 rank the one or more potential beam pairs. Then, the UEs 105 select one of the one or more potential beam pairs for the sidelink 125, perhaps based on the ranking.

As stated, the air interface between two or more UEs 105 or between a UE 105 and a UE-type RSU (not shown in FIG. 1) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105 may connect with base station 110-1 via link 120 and simultaneously connect with UE 105-2 via sidelink 125.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to perform sidelink beam failure recovery procedures. The communication system 100 can enable or disable support of the sidelink beam failure recovery procedures in the UEs 105. More specifically, the communication system 100 can enable or disable support per resource pool (e.g., for a particular set of resources) or per PC5-RRC configuration (e.g., for a particular sidelink channel between to UEs, which may depend on UE capability). In the sidelink beam failure recovery procedures, one of the UEs 105 is designated as a transmitter UE (e.g., UE 105-1) and the other UE is designated as a receiver UE (e.g., UE 105-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

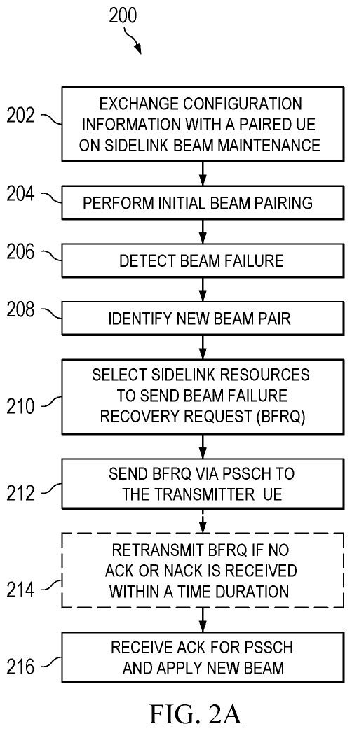

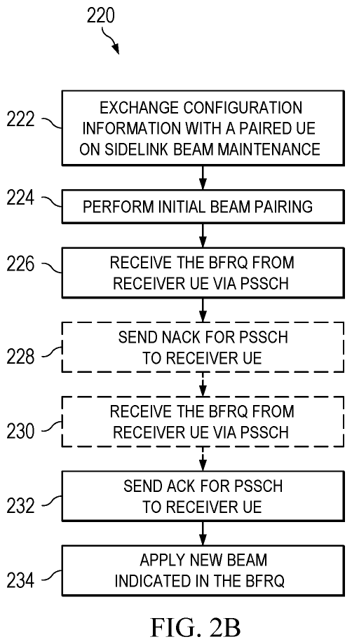

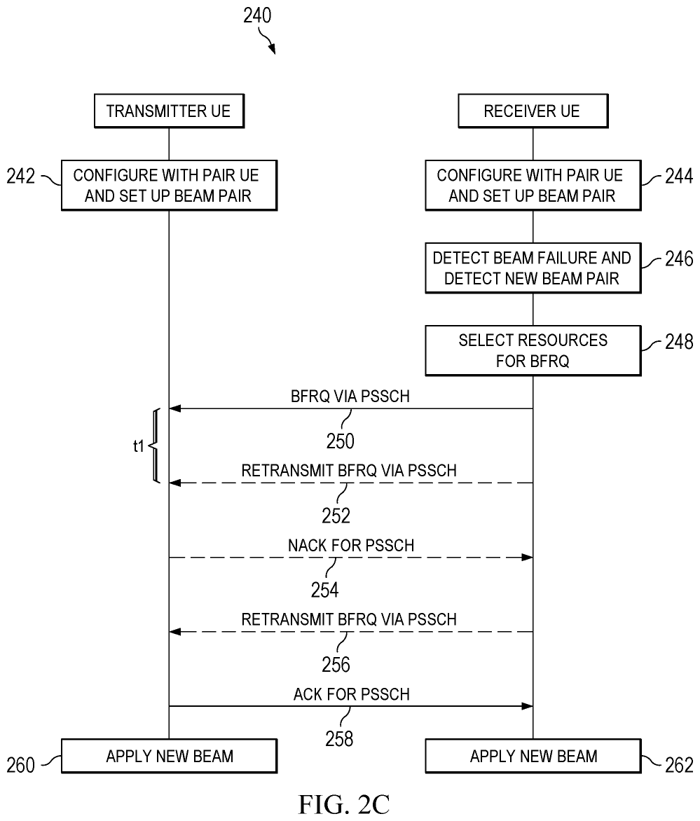

FIG. 2A and FIG. 2B illustrate flowcharts of an example sidelink beam failure recovery procedure, according to some implementations. More specifically, FIG. 2A illustrates a flowchart 200 of the sidelink beam failure recovery procedure from the perspective of a receiver UE, and FIG. 2B illustrates a flowchart 220 of the sidelink beam failure recovery procedure from the perspective of a transmitter UE. The transmitter UE and the receiver UE are paired UEs that are communicatively coupled via sidelink (e.g., UEs 105 of FIG. 1).

Starting with FIG. 2A, the receiver UE, at block 202, exchanges configuration information with the transmitter UE (e.g., the paired UE) on sidelink beam maintenance. In some examples, the configuration information can include an RSRP-threshold for detecting whether the beam has failed. Additionally and/or alternatively, the configuration information can include beam a FailureRecoveryTimer for the beam failure recovery procedure time. At block 204, the receiver UE performs initial beam pairing with the transmitter UE (e.g., using the beam pairing procedure described above) to select a sidelink serving beam pair. At block 206, the receiver UE detects a failure of the serving sidelink beam pair (e.g., failure of the transmitter beam and/or the receiver beam). At block 208, the receiver UE identifies a new beam pair to use for the sidelink. The new beam pair can be a previously identified candidate beam pair, perhaps identified during the initial beam pairing procedure.

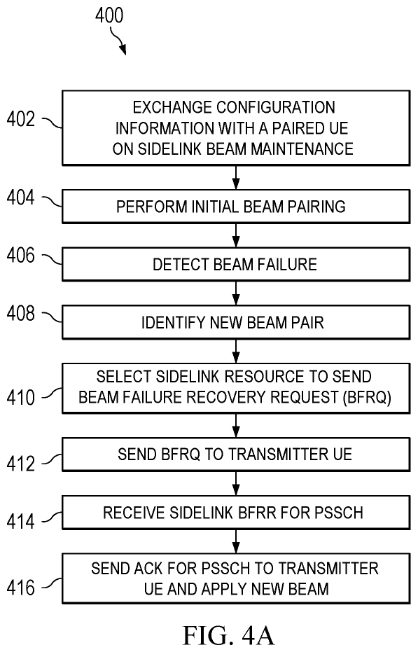

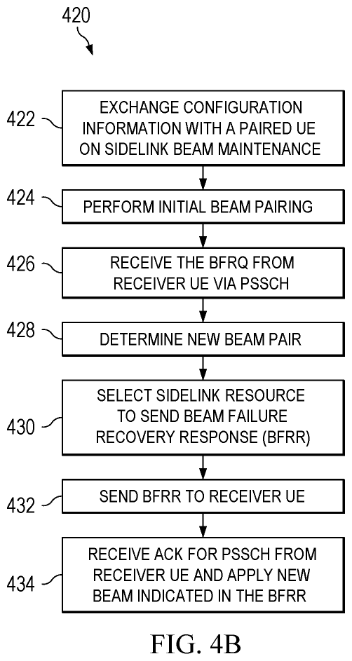

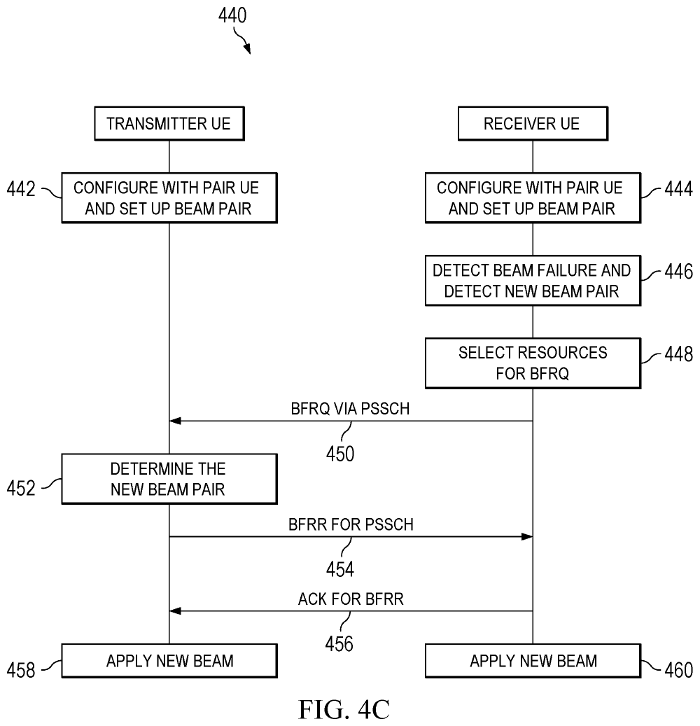

At block 210, the receiver UE selects a sidelink resource for sending a beam failure recovery request (BFRQ) to the transmitter UE. The BFRQ includes information indicative of the identified or candidate beam pair. At block 212, the receiver UE sends the BFRQ to the transmitter UE via PSSCH. At block 214, if a response is not received from the transmitter UE within a threshold period of time or if a NACK is received from the transmitter UE, the receiver UE retransmits the BFRQ. At block 216, the receiver UE receives an ACK for the PSSCH and responsively applies the new beam pair. In some examples, a beam failure recovery response (BFRR) can be sent to the receiver UE instead of or in addition to the ACK, such as described below with reference to FIGS. 4-6. Note that block 214 occurs only in certain scenarios, and therefore, can be skipped in other scenarios. As an example, the receiver UE may receive an ACK from the transmitter UE after block 212, and in this scenario, block 214 is skipped. Blocks 206-216 are described in more detail below.

Turning to FIG. 2B, the transmitter UE, at block 222, exchanges configuration information with the receiver UE (e.g., the paired UE) on sidelink beam maintenance. At block 224, the transmitter UE performs initial beam pairing with the receiver UE. At block 226, the transmitter UE receives the BFRQ from the receiver UE via the PSSCH. At block 228, if the transmitter UE cannot read the BFRQ, the transmitter UE sends a NACK for the PSSCH to the receiver UE. At block 230, the transmitter UE receives a retransmitted BFRQ from the receiver UE via PSSCH. At block 232, if the transmitter UE can read the BFRQ and determines that the new beam pair is acceptable, the transmitter UE sends an ACK for the PSSCH to the receiver UE. In some examples, a BFRR can be sent to the receiver UE instead of or in addition to the ACK, such as described below with reference to FIGS. 4-6. At block 234, the transmitter UE applies the new beam pair indicated in the BFRQ. Note that blocks 228 and 230 occur only in certain scenarios and therefore can be skipped in other scenarios. Blocks 222-234 are described in more detail below.

FIG. 2C illustrates a call flow 240 of the example sidelink beam failure recovery procedure shown in FIG. 2A and FIG. 2B. As shown in FIG. 2C, at blocks 242 and 244, the transmitter and receiver UEs exchange configuration information and set up an initial beam pair for sidelink communications. At block 246, the receiver UE detects a beam failure and responsively identifies a new candidate beam pair. At block 248, the receiver UE then selects resources for sending the BFRQ to the transmitter UE. At 250, the receiver UE sends the BFRQ via PSSCH to the transmitter UE. If the receiver UE does not receive a response from the transmitter UE within a threshold time, t1, the receiver UE, at 252, retransmits the BFRQ via PSSCH. At 254, if the transmitter UE cannot read the BFRQ, the transmitter UE sends a NACK for the PSSCH to the receiver UE. In response to receiving the NACK, the receiver UE at 256 retransmits the BFRQ via PSSCH. At 258, if the transmitter UE can read the BFRQ and determines that the candidate beam pair is acceptable, the transmitter UE sends an ACK for the PSSCH. In some examples, a BFRR can be sent to the receiver UE instead of or in addition to the ACK. At blocks 262, 264 the transmitter UE and the receiver UE apply the new beam pair indicated in the BFRQ. Note that blocks 252, 254, 256 occur only in certain scenarios and therefore can be skipped in other scenarios.

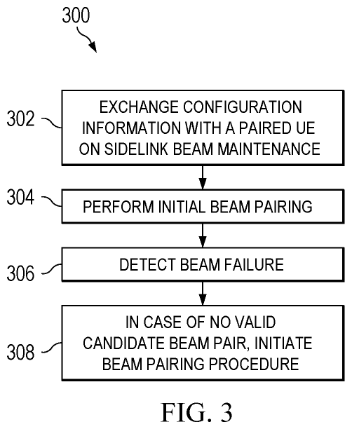

FIG. 3 illustrates a flowchart 300 of another example sidelink beam failure recovery procedure, according to some implementations. This sidelink beam failure recovery procedure can be used in scenarios where the UEs 105 do not have any candidate beam pairs. The flowchart 300 describes the procedure from the perspective of a receiver UE. At block 302, the receiver UE exchanges configuration information with a paired UE (e.g., the transmitter UE) on sidelink beam maintenance. At block 304, the receiver UE performs initial beam pairing with the transmitter UE. Here, the initial beam pairing merely identifies one beam pair, which is then used for the sidelink connection. At block 306, the receiver UE detects a beam failure. At block 308, the receiver UE, because there are no other candidate beam pairs, initiates a new beam pairing procedure.

In some implementations, the UEs 105 are configured to initiate a sidelink beam failure recovery procedure in response to determining a failure of a sidelink serving beam (e.g., see description in relation to FIG. 2A at 206 or FIG. 3 at 306). In one example, the UEs 105 determine a serving beam failure by detecting one or more failure events. A first failure event, Event 1, occurs when a measured serving beam Reference Signal Received Power (RSRP) is below a predetermined threshold. A second failure event, Event 2, occurs when N consecutive measured serving beam RSRPs are below a predetermined threshold. For this failure event, the evaluation interval for each measurement can be predefined or configured by higher layer signaling (e.g., via PC5-RRC or resource pool configuration). A third failure event, Event 3, occurs when all the measured serving beam RSRPs during a certain duration is below a predetermined threshold. A fourth failure event, Event 4, occurs when one or more of Events 1-3 occur and a candidate beam pair has an RSRP above a predetermined threshold. A fifth failure event, Event 5, occurs when one or more of Events 1-3 occur and a candidate beam pair has an RSRP some predetermined offset above the serving beam RSRP.

In some implementations, metrics other than RSRP can be used for the described failure events. In an example, a hypothetical block error ratio (BLER) or beam Signal to Interference & Noise Ratio (SINR) can alternatively be used as the measurement metric. In some examples, both RSRP and hypothetical BLER can be used as the metric, and beam failure is declared when an event for one metric occurs. In these examples, the BFRQ is used to report the metric for the corresponding event. In some examples, whether to use RSRP or hypothetical BLER (or another metric) can be configured by higher layer signaling.

In some implementations, the UEs 105 are configured with one or more mechanisms for performing the measurements associated with a failure event. In a first mechanism, the measurement metric (e.g., serving beam RSRP or hypothetical BLER) is based on a demodulation reference signal (DMRS) of PSCCH. In a second mechanism, the measurement metric is specified in a resource pool (pre)configuration as based on DMRS of PSCCH or PSSCH. In some examples, the same or a different (pre)configuration can be used for the RSRP measurement in mode-2 resource allocation. In a third mechanism, the measurement metric is based on CSI-RS. In this mechanism, a transmitter UE can send a burst CSI-RS to a receiver UE for fast beam failure detection. Alternatively, the transmitter UE may trigger periodic CSI-RS for beam failure detection. In some mechanisms, the hypothetical BLER may be measured based on a predefined configuration of PSSCH or PSCCH. As an example, the hypothetical BLER may be measured based on DMRS pattern, MCS, PTRS pattern, and/or PSSCH symbol length. As another example, the hypothetical BLER may be measured based on frequency resources of PSCCH and/or PSCCH symbol length.

In some implementations, in response to determining a serving beam failure, the UEs 105 are configured to identify a new sidelink beam different from the serving beam. In one example, the UEs can identify the new sidelink beam based on a sidelink beam measurement during a beam maintenance procedure. In some examples, a validity timer is applied to the sidelink beam measurement results. More specifically, a UE starts the validity timer after identifying one or more beam pairs (e.g., based on beam measurement). Once the validity timer expires, the measured sidelink beam results are no longer used, and another beam maintenance procedure may be triggered. The validity timer may be configured between the UEs 105 or predetermined per resource pool.

In some implementations, a receiver UE transmits a sidelink BFRQ in response to determining a serving beam failure. The BFRQ can include one or more fields. In one example, a BFRQ includes a single sidelink transmit beam ID. Thus, in this example, if multiple candidate transmitter beams are identified, then the receiver UE transmits the BFRQ multiple times, one instance per corresponding identified transmitter beam. The order in which the multiple BFRQs are transmitted may depend on the measurement of the associated beam. For example, the receiver UE may send a transmitter beam ID corresponding to the largest RSRP measurement, then may send transmitter beam ID corresponding to the second largest RSRP measurement, and so on. Alternatively, the BFRQ can include a plurality of sidelink transmit beam IDs. In another example, the BFRQ includes one or more sidelink beam pair (transmit beam and receiver beam) IDs (e.g., a sidelink CSI-RS resource IDs). In some examples, the BFRQ also includes a measured RSRP for the indicated sidelink beam (or beam pair).

In some implementations, the receiver UE is configured to use one of several container options for the BFRQ report. The container can be a Medium Access Control (MAC) Control Element (CE) on PSSCH (e.g., a sidelink BFR MAC CE), a PC5-RRC on PSSCH, and/or SCI stage 2 on PSSCH. For the SCI stage 2, a new SCI stage 2 format can be used for indicating the candidate beam (or beam pair). In some examples, if multiple transmissions with different transmitter beam IDs are transmitted, these transmissions can be considered as blind retransmissions of the same (dummy) transport block (TB).

In some implementations, the receiver UE is configured to select resources for transmitting the sidelink BFRQ. In some examples, the packet delay budget, data priority, and/or the number of time resources can be (pre)configured per resource pool, can be PC5-RRC configured between the two UEs, can depend on the sidelink unicast link configuration, or can depend on a configured validity timer (described above). In some examples, the number of frequency resources is 1 and the resource reservation periodicity is 0. In some examples, the sidelink HARQ-ACK is enabled via SCI stage 2. In some examples, the receiver UE is configured to transmit the sidelink BFRQ together with sidelink data transmission.

In some implementations, the receiver UE selects a beam for transmitting the sidelink BFRQ. In one example, the receiver UE uses a beam that corresponds to the receiver beam in the identified new beam pair. In another example, the receiver UE is configured to use the beam that corresponds to the receiver beam in the current serving beam pair. In yet another example, the receiver UE uses different beams for multiple re-transmissions. The different beams can include the beam corresponding to the receiver beam in the new beam pairs and/or the current beam pair.

In a further example, the receiver UE selects the beam based on the beam measurement results. For instance, if the RSRP of the current serving beam pair is still considered acceptable (e.g., greater than a predetermined threshold), then the receiver UE uses the receiver beam in the current serving beam pair. Otherwise, the receiver UE uses the beam that corresponds to the receiver beam in the identified new beam pair. As another illustration, if the RSRP of the candidate beam pair is greater than the current serving beam pair, then the receiver UE uses the beam corresponding to the receiver beam in the identified new beam pair. Otherwise, the receiver UE uses the beam that corresponds to the receiver beam in the current beam pair.

In some implementations, if carrier aggregation is enabled, the receiver UE can transmit the sidelink BFRQ in the FR1 component carrier. In some implementations, the receiver UE uses an omni-directional transmission to transmit the sidelink BFRQ. As described previously, in some implementations, the receiver UE may be configured to transmit multiple transmissions of sidelink BFRQ, where each BFRQ indicates a candidate beam pair using the corresponding transmission beam. In these implementations, the receiver UE selects a beam for each transmission. In a first example, the receiver UE selects the beam pair with the largest measured RSRP of BFRQ. In a second example, the receiver UE selects the beam pair with the first candidate beam if its measured RSRP is above a threshold.

In some implementations, the receiver UE and the transmitter UE are configured to activate a new beam pair. In some examples, the UEs may activate the new beam pair in a slot that is a predetermined time after the slot of the ACK to the BFRQ received by the receiver UE, a slot of the ACK to the BFRR, or the slot of BFRR transmission. The predetermined time, or time gap, can be (pre)configured per resource pool, configured per PC5-RRC, pre-defined (e.g., 2 or 3 logical slots, or the first logical slot after 2 or 3 physical slots), and/or based on UE capability. Both the transmitter and the receiver UE know the starting time (e.g., slot) to use the new beam pair. This time gap is used by UEs to adjust their sidelink transmit or receiver beam.

In some implementations, the transmitter UE transmits an ACK to the receiver UE. In some examples, using a legacy PSFCH for communicating the HARQ ACK for the PSSCH (that includes the BFRQ) autonomously indicates switching of the current beam pair to the candidate beam pair indicated in the BFRQ. In some examples, the transmitter UE may not send an ACK when it detects PSSCH, but determines not to switch the serving beam. For example, if the measured RSRP of the candidate beam is below a predetermined threshold, then the transmitter UE may consider that the beam pair is not acceptable. In some implementations, a new PSFCH format is used for BFRQ. In these implementations, a time gap between a new PSFCH format and BFRQ could be larger than that between legacy PSFCH for SL HARQ and PSSCH (to allow beam switching processing time).

In some implementations, if the BFRQ transmission is multiplexed with sidelink data transmission, then the transmitter UE can send separate PSFCH transmissions for each communication. For example, the transmitter UE can send a first PSFCH transmission with the SL HARQ for sidelink data, and a second PSFCH transmission with the BFRR. In some implementations, dedicated PSFCH resources (e.g., frequency resources) are allocated for the separate PSFCH transmissions. Decoding of SCI stage 2 for BFRQ may lead to confirmation of beam switching (e.g., ACK on PSFCH with BFRR). In some implementations, if multiple BFRQs with different beams are transmitted, then the PSFCH is only after the BFRQ transmitted in the selected beam pair.

In some implementations, if the receiver UE does not receive an ACK to BFRQ (or BFRR) within a threshold period and/or the receiver UE still detects the failure of current serving beam since last transmission of BFRQ, then the receiver UE is configured to retransmit the sidelink BFRQ. The time period may be (pre)configured per resource pool or PC5-RRC configured. In some examples, the time period depends on a channel busy ratio (CBR). In these examples, for a large CBR (e.g., a CBR greater than a threshold), the time period is longer since, in those scenarios, it is challenging for the transmitter UE to select a good sidelink resource for transmitting ACK. In some examples, the time period may be predetermined (e.g., 4 slots). In some examples, the maximum number of BFRQ retransmissions can be predefined or configured. When the number of retransmission reaches the maximum number, the sidelink between the two UEs is assumed to be link failure.

FIG. 4A and FIG. 4B illustrate flowcharts of an example sidelink beam failure recovery procedure, according to some implementations. More specifically, FIG. 4A illustrates a flowchart 400 of the sidelink beam failure recovery procedure from the perspective of a receiver UE, and FIG. 4B illustrates a flowchart 420 of the sidelink beam failure recovery procedure from the perspective of a transmitter UE. The transmitter UE and the receiver UE are paired UEs that are communicatively coupled via sidelink (e.g., UEs 105 of FIG. 1).

Referring to FIG. 4A, at block 402, the receiver UE exchanges configuration information with the transmitter UE (e.g., the paired UE) on sidelink beam maintenance. At block 404, the receiver UE performs initial beam pairing with the transmitter UE. At block 406, the receiver UE detects a failure of the serving sidelink beam pair (e.g., failure of the transmitter beam and/or the receiver beam). At block 408, the receiver UE uses the techniques described herein to identify one or more new beam pair(s) to use for sidelink communications. The receiver UE then selects 410 a sidelink resource, such as one or more of the beam pair(s) identified at 408, for sending a BFRQ (or multiple BFRQs) to the transmitter UE. At block 412, the receiver UE uses the selected resource to send the BFRQ(s) to the transmitter UE via PSSCH. At block 414, the receiver UE receives a sidelink BFRR for the PSSCH. Details regarding the content and transmission of the BFRR are discussed below. After receiving the BFRR, the receiver UE sends 416 an ACK for the PSSCH to the transmitter UE and applies the new beam pair.

Turning to FIG. 4B, at block 422, the transmitter UE exchanges configuration information with the receiver UE (e.g., the paired UE) on sidelink beam maintenance. At block 424, the transmitter UE performs initial beam pairing with the receiver UE. At block 426, the transmitter UE receives the BFRQ(s) from the receiver UE via PSSCH. The transmitter UE then determines 428 the new beam pair, as discussed in detail below. At block 430, the transmitter UE selects a sidelink resource to send the BFRR. The transmitter UE uses the selected sidelink resource to the 432 the BFRR to the receiver UE. At block 434, the transmitter UE receives an ACK for PSSCH from the receiver UE and applies the new beam pair (e.g., the beam pair indicated in the BFRR).

FIG. 4C illustrates a call flow 440 of the example sidelink beam failure recovery procedure shown in FIG. 4A and FIG. 4B. At blocks 442 and 444, the transmitter and receiver UEs exchange configuration information and set up an initial beam pair for sidelink communications. At block 446, the receiver UE identifies a beam failure and responsively identifies one or more new candidate beam pairs. At block 448, the receiver UE selects resources for sending a BFRQ (or multiple BFRQs) to the transmitter UE. The receiver UE then sends 450 the BFRQ(s) via PSSCH to the transmitter UE. At block 452, the transmitter UE determines the new beam pair for subsequent sidelink communications. The transmitter UE then sends 454 a BFRR for the PSSCH indicating the new beam (or beam pair). In response, the receiver UE sends 456 an ACK for the BFRR. At blocks 458 and 460, the transmitter UE and the receiver UE apply the new beam pair (e.g., the beam pair indicated in the BFRR).

In some implementations, the transmitter UE is configured to determine the new sidelink beam pair after receipt of the BFRQ from the receiver UE. For example, assume that multiple candidate beams or beam pairs are identified by the receiver UE. In this example, the receiver UE can transmit the BFRQ multiple times with different beams, and the transmitter UE can measure the RSRP of each BFRQ transmission. If the measured RSRP of a BFRQ transmission satisfies a threshold value, then the transmitter UE can select the corresponding beam (e.g., transmitter beam ID) or beam pair (e.g., transmitter-receiver beam pair ID) indicated in the BFRQ for the new beam pair. In some implementations, the order in which the multiple BFRQs are transmitted can depend on the RSRP or other measurement of the associated beam. For example, the receiver UE may send a BFRQ having a transmitter beam ID (or beam pair ID) corresponding to the largest RSRP measurement, then may send a BFRQ having a transmitter beam ID (or beam pair ID) corresponding to the second largest RSRP measurement, and so on. The transmitter UE can then select the beam (e.g., transmitter beam ID) or beam pair (e.g., beam pair ID) indicated in the first BFRQ transmission having an RSRP that satisfies the threshold value. In this manner, the number of BFRQ transmissions by the receiver UE and the number of RSRP measurements by the transmitter UE can be reduced. In some implementations, the transmitter UE records RSRP information for candidate beams or beam pairs during, for example, beam maintenance, and selects the new beam or beam pair from those indicated in the BFRQ based on the recorded information. For example, the transmitter UE can select the beam or beam pair having the greatest stored RSRP measurement from the beam or beam pairs indicated in the BFRQ.

Once the new beam pair is determined, the transmitter UE can indicate the selected receiver beam or beam pair in the BFRR. In general, the BFRR can include an ID for the selected receiver beam or beam pair (e.g., SL CSI-RS resource set). In some implementations, the beam or beam pair is explicitly indicated in the BFRR using, for example, a receiver beam ID or beam pair ID. In some implementations, the beam or beam pair is implicitly indicated by, for example, BFRR resource selection. For instance, multiple candidate BFRR resources can be configured for the UEs, with each resource corresponding to a beam reported in the BFRQ. Under this scheme, the transmitter UE can transmit the BFRR using the resource corresponding to the selected beam to indicate the selected beam or beam pair. In some implementations, the transmitter UE is configured to an SCI stage 2, a MAC CE, or a PC5-RRC as a container for the BFRR.

In some implementations, the transmitter UE is configured to select resources for transmitting the BFRR. For example, the packet delay budget, data priority, and/or the number of time resources can be (pre)configured per resource pool, can be PC5-RRC configured between the two UEs, can depend on the sidelink unicast link configuration, or can depend on a configured validity timer (as described above). In some implementations, the number of frequency resources is 1 and the resource reservation periodicity is 0. In some implementations, the number of time resources is (pre)configured per resource pool or PC5-RRC configured between the two UEs. In some implementations, the sidelink HARQ-ACK is enabled via SCI stage 2.

In some implementations, the transmitter UE selects a beam for transmitting the BFRR. For example, the transmitter UE can use the beam that corresponds to the transmitter beam in the identified new beam pair. In another example, the transmitter UE is configured to use the beam that corresponds to the transmitter beam in the current serving beam pair. In yet another example, the transmitter UE transmits the BFRR multiple times with different beams including, but not limited to, the beams corresponding to the transmitter beam in the new beam pair and/or the current serving beam pair and/or the transmitter beam in the beam pairs reported in BFRQ. In a further example, the transmitter UE selects the beam for transmitting the BFRR based on beam measurement results. For instance, if the RSRP of the current serving beam pair is still considered acceptable (e.g., greater than a predetermined threshold), then the transmitter UE uses the transmitter beam in the current serving beam pair. Otherwise, the transmitter UE uses the beam that corresponds to the transmitter beam in the identified new beam pair. As another illustration, if the RSRP of the candidate beam pair is greater than the current serving beam pair, then the transmitter UE uses the beam corresponding to the transmitter beam in the identified new beam pair. Otherwise, the transmitter UE uses the beam that corresponds to the transmitter beam in the current beam pair. In another example, the transmitter UE uses an omni-directional transmission to transmit the BFRR.

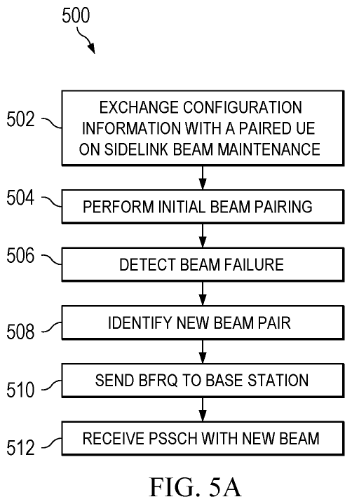

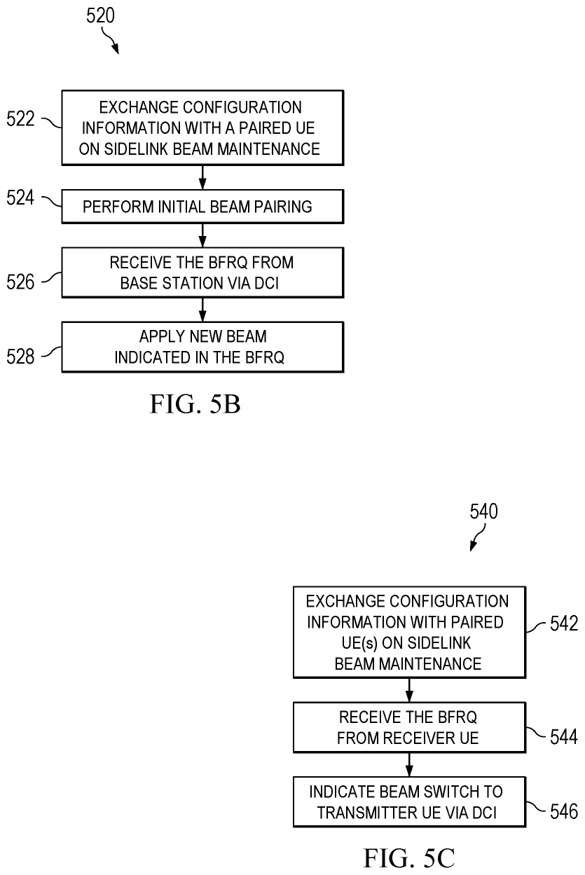

FIGS. 5A, 5B, and 5C illustrate flowcharts of an example sidelink beam failure recovery procedure in mode 1, in accordance with some implementations. More specifically, FIG. 5A illustrates a flowchart 500 of a sidelink beam failure recovery procedure in mode 1 from the perspective of a receiver UE, FIG. 5B illustrates a flowchart 520 of the sidelink beam failure recovery procedure in mode 1 from the perspective of a transmitter UE, and FIG. 5C illustrates a flowchart 540 of the sidelink beam failure recovery procedure in mode 1 from the perspective of a base station. The transmitter UE and the receiver UE are paired UEs that are communicatively coupled via sidelink (e.g., UEs 105 of FIG. 1), and the base station (e.g., base station 110 of FIG. 1) assists with establishing sidelink communications between the UEs.

Referring to FIG. 5A, at block 502, the receiver UE exchanges configuration information with the transmitter UE (e.g., the paired UE) on sidelink beam maintenance. At block 504, the receiver UE performs initial beam pairing with the transmitter UE (e.g., using the beam pairing procedure described above) to select a sidelink serving beam pair. At block 506, the receiver UE detects a failure of the serving sidelink beam pair (e.g., failure of the transmitter beam and/or the receiver beam). At block 508, the receiver UE identifies a new beam pair to use for the sidelink. The receiver UE then sends 510 a BFRQ to the base station. At block 512, the receiver UE receives a PSSCH transmission from the transmitter UE using the new beam.

Turning to FIG. 5B, at block 522, the transmitter UE exchanges configuration information with the receiver UE (e.g., the paired UE) on sidelink beam maintenance. At block 524, the transmitter UE performs initial beam pairing with the receiver UE. At 526, the transmitter UE receives the BFRQ (e.g., an indication of the beam and/or beam switch) from the base station via DCI. The transmitter UE then applies 528 the new beam indicated in the BFRQ to enable subsequent sidelink communications with the receiver UE.

Referring to FIG. 5C, at block 542, the base station exchanges configuration information with the receiver UE, the transmitter UE, or both during sidelink beam maintenance (e.g., over a non-sidelink air interface). In some implementations, block 542 may occur only in certain scenarios, and therefore, can be skipped in other scenarios. At block 544, the base station receives the BFRQ from the receiver UE. After receiving the BFRQ from the receiver UE, at block 546, the base station forwards the BFRQ or otherwise indicates the beam and/or beam switch to the transmitter UE via DCI.

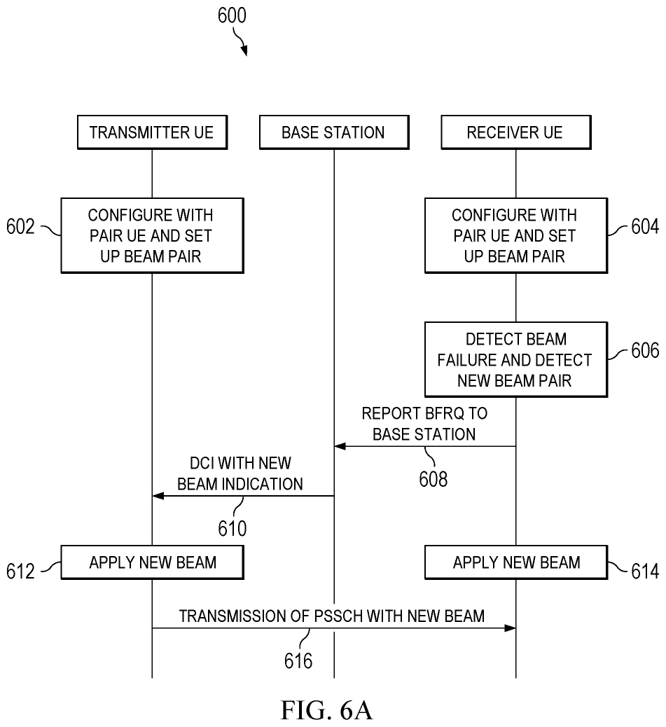

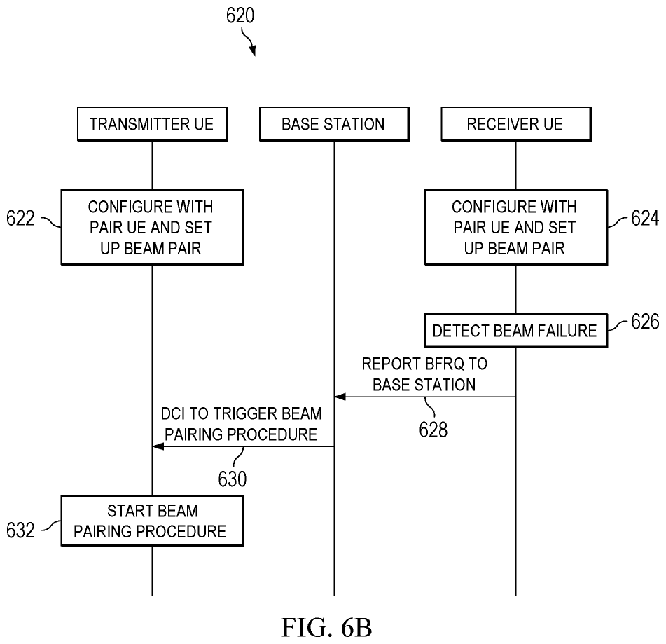

FIG. 6A illustrates a call flow 600 of the example sidelink beam failure recovery procedure shown in FIG. 5A, FIG. 5B, and FIG. 5C. At blocks 602 and 604, the transmitter and receiver UEs exchange configuration information and set up an initial beam pair for sidelink communications. At block 606, the receiver UE identifies a beam failure and responsively identifies one or more new candidate beam pairs. The receiver UE then reports 608 the BFRQ to the base station. In the BFRQ report to the base station, the receiver UE can indicate a new candidate beam or beam pair to be used, and the timing for application of the new beam or beam pair.

At 610, the base station sends DCI to the transmitter UE with an indication of the new beam or beam pair. For example, a new DCI format (e.g., DCI format 3_2) can be defined and used to provide the indication of the new beam. As another example, an existing DCI format (e.g., DCI format 3_0) can be modified to provide the indication of the new beam, such as by reusing the padding bits to indicate the beam ID or beam pair ID. In some implementations, a MAC CE or other higher layer signaling can be used to indicate the new beam instead of DCI. At blocks 612 and 614, the transmitter UE and the receiver UE apply the new beam pair for subsequent sidelink communications. At 616, the transmitter UE transmits PSSCH with the new beam.

FIG. 6B illustrates a call flow 620 of another example of the beam failure recovery procedure shown in FIG. 5A, FIG. 5B, and FIG. 5C. Initially, at blocks 622 and 624, the transmitter and receiver UEs exchange configuration information and set up an initial beam pair for sidelink communications. At block 626, the receiver UE identifies a beam failure. However, in this example, the receiver UE does not identify any new candidate beam pairs. Instead, the receiver UE reports 628 the BFRQ to the base station with an indication that the current serving beam pair between the transmitter UE and the receiver UE has failed. Responsive to the report, the base station sends 630 DCI to the transmitter UE to trigger a beam pairing procedure (e.g., the initial beam pairing procedure). The trigger can be a single bit in the DCI format, such as the DCI format 3_1 or another new or existing DCI format. Upon receipt of the trigger, the transmitter UE can start 632 the beam pairing procedure.

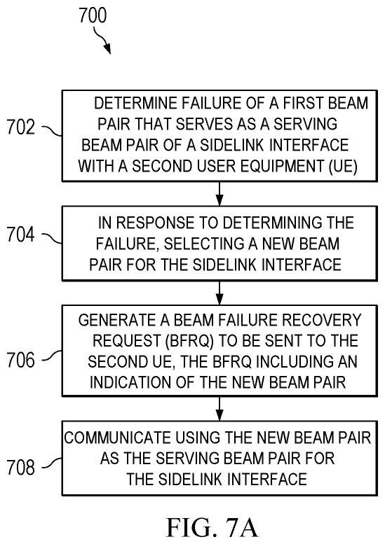

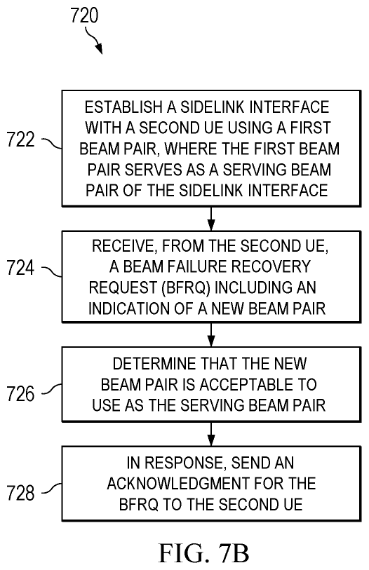

FIG. 7A illustrates a flowchart of an example method 700, according to some implementations. For clarity of presentation, the description that follows generally describes method 700 in the context of the other figures in this description. For example, method 700 can be performed by UEs 105 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order. In some implementations, method 700 is performed by a first UE.

At block 702, method 700 involves determining failure of a first beam pair that serves as a serving beam pair of a sidelink interface with a second UE.

At block 704, method 700 involves in response to determining the failure, selecting a new beam pair for the sidelink interface.

At block 706, method 700 involves generating a beam failure recovery request (BFRQ) to be sent to the second UE, the BFRQ including an indication of the new beam pair.

At block 708, method 700 involves communicating using the new beam pair as the serving beam pair for the sidelink interface.

In some implementations, method 700 further involves receiving, from a base station, a configuration enabling a beam failure recovery mechanism for the sidelink interface.

In some implementations, sending, to the second UE, the beam failure recovery request (BFRQ) includes: sending the BFRQ to the second UE via a Physical Sidelink Shared Channel (PSSCH) of the sidelink interface.

In some implementations, the BFRQ includes at least one sidelink beam identifier (ID).

In some implementations, the BFRQ includes a measurement of the first beam pair.

In some implementations, generating the BFRQ to be sent to the second UE involves selecting a transmission beam for sending the BFRQ to the second UE.

In some implementations, selecting the transmission beam for sending the BFRQ to the second UE involves selecting the transmission beam from at least one of: (i) the new beam pair, (ii) the first beam pair, or (iii) an omni-directional beam.

In some implementations, selecting the transmission beam for sending the BFRQ to the second UE involves selecting more than one transmission beam for more than one transmission of the BFRQ from at least one of the new beam pair or the first beam pair.

In some implementations, communicating using the new beam pair as the serving beam pair for the sidelink interface involves: communicating using the new beam pair as the serving beam pair for the sidelink interface in response to receiving an acknowledgment from the second UE for the BFRQ.

In some implementations, receiving the acknowledgment from the second UE for the BFRQ involves: receiving the acknowledgment from the second UE via a Physical Sidelink Feedback Channel (PSFCH) of the sidelink interface.

In some implementations, determining failure of the first beam pair involves: determining a failure event associated with the first beam pair, where the failure event is one of: determining that a first measured metric of the first beam pair is less than a first predetermined threshold; determining that at least N consecutive instances of the first measured metric are below a second predetermined threshold; or determining that at least one instance of the first measured metric during a first duration is below a third predetermined threshold.

In some implementations, where the first measured metric is a Reference Signal Received Power (RSRP) or hypothetical block error ratio (BLER) of at least one beam of the first beam pair.

In some implementations, where the first measured metric is measured based on a DMRS of PSCCH or PSSCH or based on a sidelink CSI-RS.

In some implementations, determining the failure event associated with the first beam pair further involves: determining that a second measured metric of a candidate beam pair is above a fourth predetermined threshold; or determining that that the second measured metric of the candidate beam pair is at least an predetermined offset above the first measured metric of the first beam pair.

In some implementations, selecting the new beam pair for the sidelink interface involves: identifying one or more candidate beams based on results of sidelink beam measurements during a beam maintenance procedure.

In some implementations, a validity timer is applied to the sidelink beam measurement results.

FIG. 7B illustrates a flowchart of an example method 720, according to some implementations. For clarity of presentation, the description that follows generally describes method 720 in the context of the other figures in this description. For example, method 720 can be performed by UEs 105 of FIG. 1. It will be understood that method 720 can be performed, for example, by any suitable system, environment, software, hardware, or a combination of systems, environments, software, and hardware, as appropriate. In some implementations, various steps of method 720 can be run in parallel, in combination, in loops, or in any order. In some implementations, method 720 is performed by a first UE.

At block 722, method 720 involves establishing a sidelink interface with a second UE using a first beam pair, where the first beam pair serves as a serving beam pair of the sidelink interface.

At block 724, method 720 involves receiving, from the second UE, a beam failure recovery request (BFRQ) including an indication of a new beam pair.

At block 726, method 720 involves determining that the new beam pair is acceptable to use as the serving beam pair.

At block 728, method 720 involves in response, sending an acknowledgment for the BFRQ to the second UE.

In some implementations, method 720 further involves communicating using the new beam pair as the serving beam pair for the sidelink interface.

In some implementations, the new beam pair is implemented as the serving beam pair after a threshold period of time from a slot in which the acknowledgment is sent to the second UE.

In some implementations, sending the acknowledgment for the BFRQ to the second UE involves sending the acknowledgement via a Physical Sidelink Feedback Channel (PSFCH) of the sidelink interface.

In some implementations, determining that the new beam pair is acceptable to use as the serving beam pair involves determining that a measurement associated with the new beam pair is greater than a predetermined threshold.

In some implementations, sending the acknowledgment for the BFRQ to the second UE involves determining that a BFRQ transmission is multiplexed with a sidelink data transmission; and sending the acknowledgment for the BFRQ separate from a response to the sidelink data transmission.

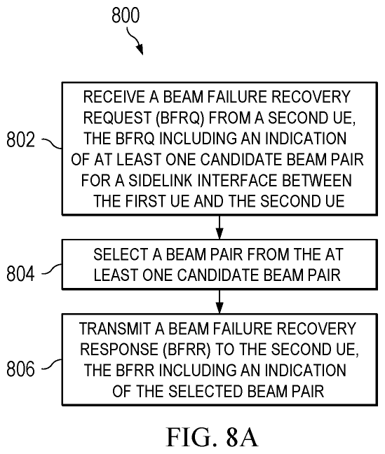

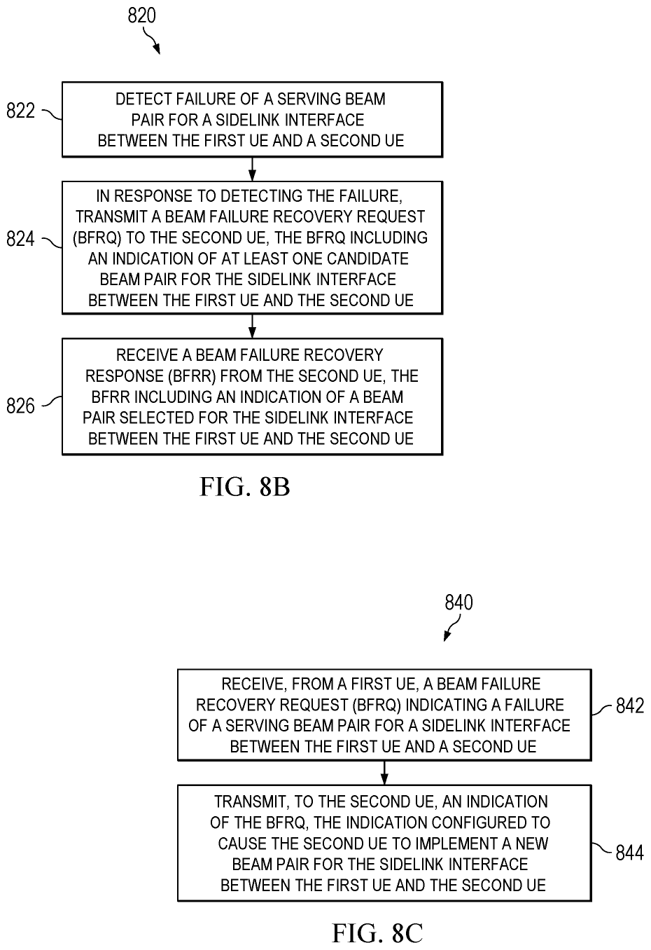

FIG. 8A illustrates a flowchart of an example method 800, according to some implementations. For clarity of presentation, the description that follows generally describes method 800 in the context of the other figures in this description. For example, method 800 can be performed by UEs 105 of FIG. 1, alone or in combination with base station 110 of FIG. 1. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order. In some implementations, method 800 is performed by a first UE.

At block 802, method 800 involves receiving one or more beam failure recovery requests (BFRQs) from a second UE. The BFRQ(s) can include an indication of at least one candidate beam or beam pair for a sidelink interface between the first UE and the second UE. In some implementations, the BFRQ is received from the second UE via a PSSCH of the sidelink interface.

At block 804, the method 800 involves selecting a beam pair from the at least one candidate beam pair. In some implementations, the first UE can measure a received signal power of the BFRQ transmission, and can select the beam pair in response to the received signal power (e.g., RSRP) of the BFRQ transmission satisfying a threshold value. In some implementations, the first UE may have previously measured and stored received signal power information for the at least one candidate beam pair before receipt of the BFRQ (e.g., during beam maintenance). In this scenario, the second UE can select the new beam or beam pair from the candidate beam pairs based on the stored received signal power information, such as by selecting the beam or beam pair having the greatest stored received signal power among the candidate beam pairs.

At block 806, the method 800 involves transmitting a beam failure recovery response (BFRR) to the second UE. The BFRR can include an indication of the selected beam or beam pair, such as a (receiver) beam ID and/or a (transmitter-receiver) beam pair ID. In some implementations, the selected beam pair is associated with a particular BFRR resource, and the BFRR is transmitted using the particular BFRR resource to implicitly indicate the selected beam pair. In some implementations, the BFRR is transmitted to the second UE via a PSSCH of the sidelink interface.

In some implementations, the first UE receives an acknowledgement (ACK) of the BFRR from the second UE. In response to the acknowledgement, the first UE (and/or the second UE) implements the selected beam pair as a serving beam pair for the sidelink interface.

FIG. 8B illustrates a flowchart of an example method 820, according to some implementations. For clarity of presentation, the description that follows generally describes method 820 in the context of the other figures in this description. For example, method 820 can be performed by UEs 105 of FIG. 1, alone or in combination with base station 110 of FIG. 1. It will be understood that method 820 can be performed, for example, by any suitable system, environment, software, hardware, or a combination of systems, environments, software, and hardware, as appropriate. In some implementations, various steps of method 820 can be run in parallel, in combination, in loops, or in any order. In some implementations, method 820 is performed by a first UE.

At block 822, the method 820 involves detecting a failure of a serving beam pair for a sidelink interface between the first UE and a second UE. At block 824, the method 820 involves transmitting one or more BFRQ(s) to the second UE in response to detecting the failure. The BFRQ(s) can include an indication of at least one candidate beam or beam pair for the sidelink interface between the first UE and the second UE. In some implementations, the BFRQ is transmitted to the second UE via a PSSCH of the sidelink interface.

At block 826, the method 820 involves receiving a BFRR from the second UE. The BFRR can include an indication of a beam or beam pair (e.g., a beam ID or beam pair ID) selected from the at least one candidate beam or beam pair for the sidelink interface. In some implementations, the BFRR is received from the second UE on a particular BFRR resource indicative of the selected beam or beam pair. In some implementations, the beam pair is selected for the sidelink interface based on a received signal power (e.g., RSRP) of the BFRQ transmission. In some implementations, the beam pair is selected based on received power information for the at least one candidate beam pair recorded before receipt of the BFRQ (e.g., during beam maintenance).

In some implementations, an acknowledgement of the BFRR is transmitted to the second UE. In response to transmitting the acknowledgement, the first UE (and/or the second UE) implements the selected beam pair as a serving beam pair for the sidelink interface.

FIG. 8C illustrates a flowchart of an example method 840, according to some implementations. For clarity of presentation, the description that follows generally describes method 840 in the context of the other figures in this description. For example, method 840 can be performed by the base station 110 of FIG. 1 that is in communication with UEs 105 of FIG. 1. It will be understood that method 840 can be performed, for example, by any suitable system, environment, software, hardware, or a combination of systems, environments, software, and hardware, as appropriate. In some implementations, various steps of method 840 can be run in parallel, in combination, in loops, or in any order. In some implementations, method 840 is performed by a base station.

At block 842, the method 840 involves receiving, from a first UE, a BFRQ indicating a failure of a serving beam pair for a sidelink interface between the first UE and a second UE. At block 844, the method 840 involves transmitting, to the second UE, an indication of the BFRQ. The indication can cause the second UE to implement a new beam pair for the sidelink interface between the first UE and the second UE. The indication of the BFRQ can be transmitted to the second UE via DCI, MAC-CE, or other higher layer signaling.

In some implementations, the BFRQ includes an indication of at least one candidate beam or beam pair for a sidelink interface between the first UE and the second UE. In this scenario, the indication of the BFRQ transmitted to the second UE can include an indication of the at least one candidate beam or beam pair. In some implementations, the BFRQ does not include an indication of any candidate beams or beam pairs, and the indication of the BFRQ transmitted to the second UE can trigger the second UE to initiate a beam pairing procedure with the first UE.

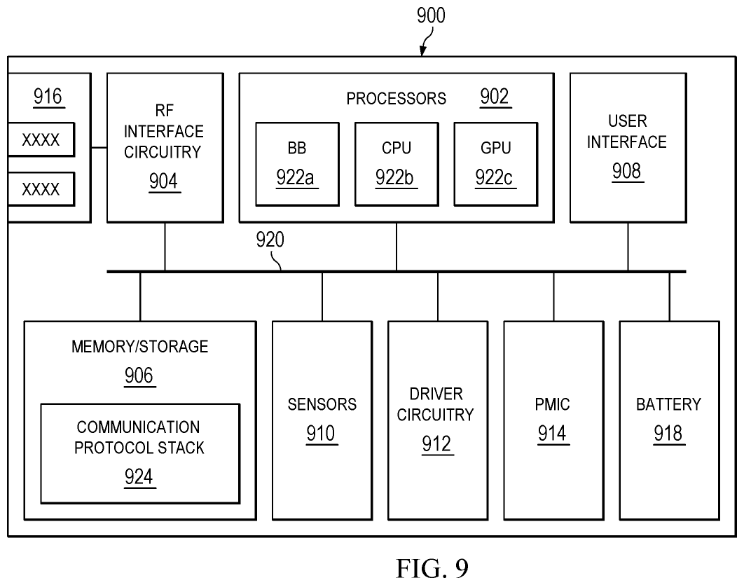

FIG. 9 illustrates a UE 900, in accordance with some implementations. The UE 900 may be similar to and substantially interchangeable with UEs 105 of FIG. 1.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antennas 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the processors 902 are processors of a first UE. In these implementations, the processors 902 are configured to determine failure of a first beam pair that serves as a serving beam pair of a sidelink interface with a second UE. The processors 902 are further configured to select, in response to determining the failure, a new beam pair for the sidelink interface. Further, the processors 902 are configured to generate a beam failure recovery request (BFRQ) to be sent to the second UE, the BFRQ including an indication of the new beam pair. Yet further, the processors 902 are configured to cause the first UE to communicate using the new beam pair as the serving beam pair for the sidelink interface.

In some implementations, the processors 902 are configured to establish a sidelink interface with a second UE using a first beam pair, where the first beam pair serves as a serving beam pair of the sidelink interface. The processors 902 are further configured to receive, from the second UE, a beam failure recovery request (BFRQ) including an indication of a new beam pair. Further, the processors 902 are configured to determine that the new beam pair is acceptable to use as the serving beam pair. Yet further, the processors 902 are configured to send an acknowledgment for the BFRQ to the second UE.

In some implementations, the processors 902 are configured to receive a beam failure recovery request (BFRQ) from a second UE, the BFRQ including an indication of at least one candidate beam pair for a sidelink interface between the first UE and the second UE. The processors 902 are further configured to select a beam pair from the at least one candidate beam pair, and cause the first UE to transmit a beam failure recovery response (BFRR) to the second UE, the BFRR including an indication of the selected beam pair.

In some implementations, the processors 902 are configured to determine failure of a serving beam pair for a sidelink interface between the first UE and a second UE. In response to determining the failure, the processors 902 are configured to cause the first UE to transmit a beam failure recovery request (BFRQ) to the second UE, the BFRQ including an indication of at least one candidate beam pair for the sidelink interface between the first UE and the second UE. The processors 902 are further configured to cause the first UE to receive a beam failure recovery response (BFRR) from the second UE, the BFRR including an indication of a beam pair selected for the sidelink interface between the first UE and the second UE.

In some implementations, the processors 902 are configured to receive, from a base station, an indication of a failure of a serving beam pair for a sidelink interface between a first UE and a second UE. In response to the indication, the processors 902 are configured to implement a new beam pair as the serving beam pair for the sidelink interface.

In some implementations, the processors 902 are configured to determine failure of a serving beam pair for a sidelink interface between a first UE and a second UE. In response to determining the failure, the processors 902 are configured to cause the first UE to transmit a beam failure recovery request (BFRQ) to a base station for forwarding to the second UE.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer.

In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antennas 916 and proceed to filter and amplify (with a low-noise amplifier) the signal. The signal may be provided to a receiver of the transceiver that down converts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antennas 916.

In various implementations, the RF interface circuitry 904 may be configured to transmit/receive signals in a manner compatible with NR access technologies.

The one or more antennas 916 may include antenna elements to convert electrical signals into radio waves to travel through the air and to convert received radio waves into electrical signals. The antenna elements may be arranged into one or more antenna panels. The one or more antennas 916 may have antenna panels that are omnidirectional, directional, or a combination thereof to enable beamforming and multiple input, multiple output communications. The one or more antennas 916 may include microstrip antennas, printed antennas fabricated on the surface of one or more printed circuit boards, patch antennas, phased array antennas, etc. The one or more antennas 916 may have one or more panels designed for specific frequency bands including bands in FRI or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 928 and control and allow access to sensors 928, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900 including DRX as discussed herein. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

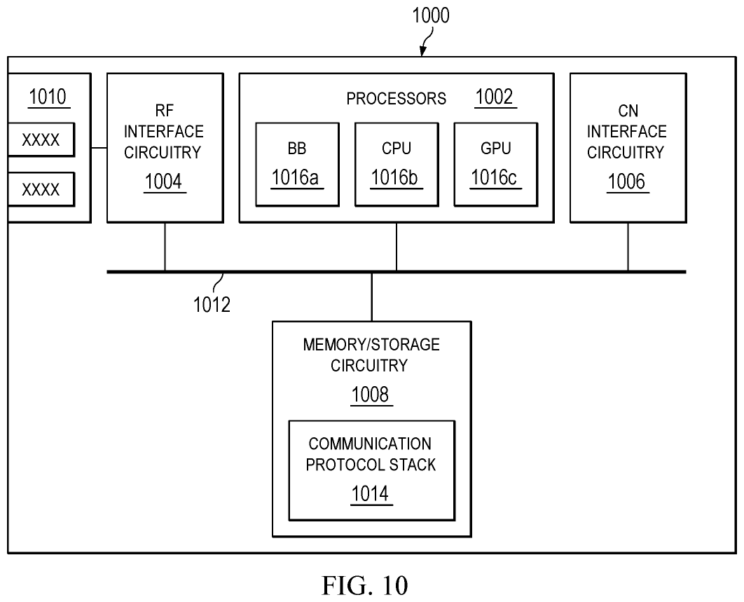

FIG. 10 illustrates an access node 1000 (e.g., abase station or gNB), in accordance with some implementations. The access node 1000 may be similar to and substantially interchangeable with base stations 110. The access node 1000 may include processors 1002, RF interface circuitry 1004, core network (CN) interface circuitry 1006, memory/storage circuitry 1008, and one or more antennas 1010.

The components of the access node 1000 may be coupled with various other components over one or more interconnects 1012. The processors 1002, RF interface circuitry 1004, memory/storage circuitry 1008 (including communication protocol stack 1014), antennas 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

In some implementations, the processors 1002 are configured to cause the access node to receive, from a first UE, a beam failure recovery request (BFRQ) indicating a failure of a serving beam pair for a sidelink interface between the first UE and the second UE. The processors 1002 are further configured to cause the access node to transmit, to the second UE, an indication of the BFRQ, the indication configured to cause the second UE to implement a new beam pair for the sidelink interface between the first UE and the second UE.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more

### EXAMPLES

In the following section, further exemplary embodiments are provided.

Example 1 includes a method to be performed by a first UE, the method involves receiving a beam failure recovery request (BFRQ) from a second UE, the BFRQ including an indication of at least one candidate beam pair for a sidelink interface between the first UE and the second UE; selecting a beam pair from the at least one candidate beam pair; and transmitting a beam failure recovery response (BFRR) to the second UE, the BFRR including an indication of the selected beam pair.

Example 2 includes a method of Example 1, the method further involves receiving an acknowledgement of the BFRR from the second UE; and in response to the acknowledgement, implementing the selected beam pair as a serving beam pair for the sidelink interface.

Example 3 includes a method of Examples 1 or 2, where selecting the beam pair involves measuring a received signal power of the BFRQ; and selecting the beam pair in response to the received signal power of the BFRQ satisfying a threshold value.

Example 4 includes a method of any of Examples 1 to 3, where selecting the beam pair involves storing received signal power information for the at least one candidate beam pair before receipt of the BFRQ; and selecting the beam pair from the at least one candidate beam pair based on the stored received signal power information, where the selected beam pair includes a candidate beam pair associated with a greatest stored received signal power.

Example 5 includes a method of any of Examples 1 to 4, where the BFRR includes a beam identifier or a beam pair identifier to indicate the selected beam pair.

Example 6 includes a method of any of Examples 1 to 5, where the selected beam pair is associated with a particular BFRR resource, and where the BFRR is transmitted to the second UE using the particular BFRR resource to indicate the selected beam pair.

Example 7 includes a method of any of Examples 1 to 6, where the BFRQ is received from the second UE via a Physical Sidelink Shared Channel (PSSCH) of the sidelink interface.

Example 8 includes a method of any of Examples 1 to 7, where the BFRR is transmitted to the second UE via a Physical Sidelink Shared Channel (PSSCH) of the sidelink interface.

Example 9 includes a method to be performed by a first UE, the method involves detecting failure of a serving beam pair for a sidelink interface between the first UE and a second UE; in response to detecting the failure, transmitting a beam failure recovery request (BFRQ) to the second UE, the BFRQ including an indication of at least one candidate beam pair for the sidelink interface between the first UE and the second UE; and receiving a beam failure recovery response (BFRR) from the second UE, the BFRR including an indication of a beam pair selected for the sidelink interface between the first UE and the second UE.

Example 10 includes a method of Example 9, where the method further involves transmitting an acknowledgement of the BFRR to the second UE; and implementing the beam pair as the serving beam pair for the sidelink interface.

Example 11 includes a method of Example 9 or 10, where the beam pair is selected for the sidelink interface based on a received signal power of the BFRQ.

Example 12 includes a method of any of Examples 9 to 11, where the beam pair is selected for the sidelink interface based on received power information recorded before receipt of the BFRQ.

Example 13 includes a method of any of Examples 9 to 12, where the BFRR includes a beam identifier or a beam pair identifier to indicate the selected beam pair.

Example 14 includes a method of any of Examples 9 to 13, where the BFRR is received from the second UE on a particular BFRR resource indicative of the selected beam pair.

Example 15 includes a method of any of Examples 9 to 14, where the BFRQ is transmitted to the second UE via a Physical Sidelink Shared Channel (PSSCH) of the sidelink interface.

Example 16 includes a method of any of Examples 9 to 15, where the BFRR is received from the second UE via a Physical Sidelink Shared Channel (PSSCH) of the sidelink interface.

Example 17 includes a method to be performed by a base station, the method involves receiving, from a first user equipment (UE), a beam failure recovery request (BFRQ) indicating a failure of a serving beam pair for a sidelink interface between the first UE and a second UE; and transmitting, to the second UE, an indication of the BFRQ, the indication configured to cause the second UE to implement a new beam pair for the sidelink interface between the first UE and the second UE.

Example 18 includes a method of Example 17, where the BFRQ includes an indication of at least one candidate beam pair for a sidelink interface between the first UE and the second UE, and where the indication of the BFRQ transmitted to the second UE includes the at least one candidate beam pair.

Example 19 includes a method of Example 17 or 18, where the indication of the BFRQ transmitted to the second UE triggers a beam pairing procedure between the first UE and the second UE.

Example 20 includes a method of any of Examples 17 to 19, where the indication of the BFRQ is transmitted to the second UE via Downlink Control Information (DCI) or a Medium Access Control (MAC) Control Element (CE).

Example 21 includes a method to be performed by a first UE, the method involves receiving, from a base station, an indication of a failure of a serving beam pair for a sidelink interface between the first UE and a second UE; and in response to the indication, implementing a new beam pair as the serving beam pair for the sidelink interface.

Example 22 includes a method of Example 21, where the indication of the failure of the serving beam pair is received via Downlink Control Information (DCI) or a Medium Access Control (MAC) Control Element (CE).

Example 23 includes a method of Example 21 or 22, where the indication of the failure of the serving beam includes an indication of at least one candidate beam pair for a sidelink interface between the first UE and the second UE, the method further involves selecting the new beam pair from the at least one candidate beam pair; and transmitting a Physical Sidelink Shared Channel (PSSCH) transmission to the second UE via a beam of the new beam pair.

Example 24 includes a method of any of Examples 21 to 23, further involves initiating a beam pairing procedure in response to the indication of the failure of the serving beam.

Example 25 includes a method to be performed by a first UE, the method includes detecting failure of a serving beam pair for a sidelink interface between the first UE and a second UE; and in response to detecting the failure, transmitting a beam failure recovery request (BFRQ) to a base station for forwarding to the second UE.

Example 26 includes a method of Example 25, where the base station is configured to forward the BFRQ to the second UE via Downlink Control Information (DCI) or a Medium Access Control (MAC) Control Element (CE).

Example 27 includes a method of any of Examples 25 or 26, where the BFRQ includes an indication of at least one candidate beam pair for a sidelink interface between the first UE and the second UE, the method further involves receiving a Physical Sidelink Shared Channel (PSSCH) transmission from the second UE with an indication of a new beam pair selected as the serving beam pair for the sidelink interface.

Example 28 includes a method of any of Examples 25 to 27, where the second UE is configured to initiate a beam pairing procedure in response to the BFRQ.

Example 29 may include one or more non-transitory computer-readable media including instructions to cause an electronic device, upon execution of the instructions by one or more processors of the electronic device, to perform one or more elements of a method described in or related to any of examples 1-28, or any other method or process described herein.

Example 30 may include an apparatus including logic, modules, or circuitry to perform one or more elements of a method described in or related to any of examples 1-28, or any other method or process described herein.

Example 31 may include a method, technique, or process as described in or related to any of examples 1-28, or portions or parts thereof.

Example 32 may include an apparatus including: one or more processors and one or more computer-readable media including instructions that, when executed by the one or more processors, cause the one or more processors to perform the method, techniques, or process as described in or related to any of examples 1-28, or portions thereof.

Example 33 may include a signal as described in or related to any of examples 1-28, or portions or parts thereof.

Example 34 may include a datagram, information element, packet, frame, segment, PDU, or message as described in or related to any of examples 1-28, or portions or parts thereof, or otherwise described in the present disclosure.

Example 35 may include a signal encoded with data as described in or related to any of examples 1-28, or portions or parts thereof, or otherwise described in the present disclosure.

Example 36 may include a signal encoded with a datagram, IE, packet, frame, segment, PDU, or message as described in or related to any of examples 1-28, or portions or parts thereof, or otherwise described in the present disclosure.

Example 37 may include an electromagnetic signal carrying computer-readable instructions, where execution of the computer-readable instructions by one or more processors is to cause the one or more processors to perform the method, techniques, or process as described in or related to any of examples 1-28, or portions thereof.

Example 38 may include a computer program including instructions, where execution of the program by a processing element is to cause the processing element to carry out the method, techniques, or process as described in or related to any of examples 1-28, or portions thereof. The operations or actions performed by the instructions executed by the processing element can include the methods of any one of examples 1-28.

Example 39 may include a signal in a wireless network as shown and described herein.

Example 40 may include a method of communicating in a wireless network as shown and described herein.

Example 41 may include a system for providing wireless communication as shown and described herein. The operations or actions performed by the system can include the methods of any one of examples 1-28.

Example 42 may include a device for providing wireless communication as shown and described herein. The operations or actions performed by the device can include the methods of any one of examples 1-28.

The previously-described examples 1-28 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-28.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users of the examples set forth below in the example section.

1. One or more processors configured to perform operations comprising:
receiving a beam failure recovery request (BFRQ) from a second user equipment (UE), the BFRQ comprising an indication of at least one candidate beam pair for a sidelink interface between a first UE and the second UE;
selecting a beam pair from the at least one candidate beam pair; and
causing transmission of a beam failure recovery response (BFRR) to the second UE, the BFRR comprising an indication of the selected beam pair.

2. The one or more processors of claim 1, the operations further comprising:
receiving an acknowledgement of the BFRR from the second UE; and
in response to the acknowledgement, implementing the selected beam pair as a serving beam pair for the sidelink interface.

3. The one or more processors of claim 1, wherein selecting the beam pair comprises:
measuring a received signal power of the BFRQ; and
selecting the beam pair in response to the received signal power of the BFRQ satisfying a threshold value.

4. The one or more processors of claim 1, wherein selecting the beam pair comprises:
storing received signal power information for the at least one candidate beam pair before receipt of the BFRQ; and
selecting the beam pair from the at least one candidate beam pair based on the stored received signal power information, wherein the selected beam pair comprises a candidate beam pair associated with a greatest stored received signal power.

5. The one or more processors of claim 1, wherein the BFRR comprises a beam identifier or a beam pair identifier to indicate the selected beam pair.

6. The one or more processors of claim 1, wherein the selected beam pair is associated with a particular BFRR resource, and wherein the BFRR is transmitted to the second UE using the particular BFRR resource to indicate the selected beam pair.

7. The one or more processors of claim 1, wherein the BFRQ is received from the second UE via a Physical Sidelink Shared Channel (PSSCH) of the sidelink interface.

8. The one or more processors of claim 1, wherein the BFRR is transmitted to the second UE via a Physical Sidelink Shared Channel (PSSCH) of the sidelink interface.

9. One or more processors configured to perform operations comprising:
detecting failure of a serving beam pair for a sidelink interface between a first user equipment (UE) and a second UE;
in response to detecting the failure, transmitting a beam failure recovery request (BFRQ) to the second UE, the BFRQ comprising an indication of at least one candidate beam pair for the sidelink interface between the first UE and the second UE; and
receiving a beam failure recovery response (BFRR) from the second UE, the BFRR comprising an indication of a beam pair selected for the sidelink interface between the first UE and the second UE.

10. The one or more processors of claim 9, the operations further comprising:
transmitting an acknowledgement of the BFRR to the second UE; and
implementing the beam pair as the serving beam pair for the sidelink interface.

11. The one or more processors of claim 9, wherein the beam pair is selected for the sidelink interface based on a received signal power of the BFRQ.

12. The one or more processors of claim 9, wherein the beam pair is selected for the sidelink interface based on received power information recorded before receipt of the BFRQ.

13. The one or more processors of claim 9, wherein the BFRR comprises a beam identifier or a beam pair identifier to indicate the selected beam pair.

14. The one or more processors of claim 9, wherein the BFRR is received from the second UE on a particular BFRR resource indicative of the selected beam pair.

15. The one or more processors of claim 9, wherein the BFRQ is transmitted to the second UE via a Physical Sidelink Shared Channel (PSSCH) of the sidelink interface.

16. The one or more processors of claim 9, wherein the BFRR is received from the second UE via a Physical Sidelink Shared Channel (PSSCH) of the sidelink interface.

17-30. (canceled)

31. A method comprising:
receiving a beam failure recovery request (BFRQ) from a second user equipment (UE), the BFRQ comprising an indication of at least one candidate beam pair for a sidelink interface between a first UE and the second UE;
selecting a beam pair from the at least one candidate beam pair; and
causing transmission of a beam failure recovery response (BFRR) to the second UE, the BFRR comprising an indication of the selected beam pair.

32. The method of claim 31, further comprising:
receiving an acknowledgement of the BFRR from the second UE; and
in response to the acknowledgement, implementing the selected beam pair as a serving beam pair for the sidelink interface.

33. The method of claim 31, wherein selecting the beam pair comprises:
measuring a received signal power of the BFRQ; and
selecting the beam pair in response to the received signal power of the BFRQ satisfying a threshold value.

34. The method of claim 31, wherein selecting the beam pair comprises:
storing received signal power information for the at least one candidate beam pair before receipt of the BFRQ; and
selecting the beam pair from the at least one candidate beam pair based on the stored received signal power information, wherein the selected beam pair comprises a candidate beam pair associated with a greatest stored received signal power.
